(19) United States
(12) Patent Application Publication
(10) Pub. No.: US 2026/0142292 A1
(43) Pub. Date: May 21, 2026

(54) BATTERY ASSEMBLY

(71) Applicant: SK On Co., Ltd., Seoul (KR)

(72) Inventors: Bon Seok KU, Daejeon (KR); Gang U LEE, Daejeon (KR); Chong Pyo HONG, Daejeon (KR)

(21) Appl. No.: 19/394,878

(22) Filed: Nov. 20, 2025

(30) Foreign Application Priority Data
Nov. 21, 2024 (KR) 10-2024-0167264

(51) Int. Cl. H01M 50/211; H01M 50/291; H01M 50/507

(52) U.S. Cl. CPC H01M 50/211; H01M 50/291; H01M 50/507

(57) ABSTRACT

The present disclosure relates to a battery assembly comprising: a plurality of battery cells each including an electrode lead tab portion; a receiving case forming a receiving space that accommodates the plurality of battery cells arranged along a predetermined first direction therein; a barrier member having a plate shape and disposed between the plurality of battery cells along the first direction in the receiving space; a base frame arranged along the first direction in the receiving space; a protrusion portion formed along a second direction, which is one of directions perpendicular to the first direction and extends from the base frame toward the barrier member, wherein at least a portion of the barrier member is inserted into the protrusion portion; and a filling member located between the barrier member and the protrusion portion along a third direction perpendicular to both the first direction and the second direction.

### CROSS-REFERENCE TO RELATED PATENT APPLICATION

The present application claims priority under 35 U.S.C. § 119(a) to Korean patent application number 10-2024-0167264 filed on November 21, 2024, in the Korean Intellectual Property Office, the entire disclosure of which is incorporated by reference herein.

### BACKGROUND OF THE INVENTION

### 1. Field

The present disclosure relates to a battery assembly.

### 2. Description of the Related Art

The operating principle of a lithium secondary battery is an electrochemical oxidation-reduction reaction. That is, electricity is generated by the movement of lithium ions, and the opposite process constitutes charging. In the case of a lithium secondary battery, the phenomenon in which lithium ions that were in the negative electrode move to the positive electrode through an electrolyte and a separator is called discharge. The reverse process of this phenomenon is called charging.

However, due to recent incidents of fire or explosion occurring during the use of lithium secondary batteries, social concerns about the safety of battery usage have been increasing. One of the main development challenges of lithium secondary batteries in recent years is to eliminate instability such as fire or explosion caused by thermal runaway of the battery cell.

In particular, in a battery module or pack, there exist empty spaces other than the battery cells, which serve as energy sources. If a fire occurs due to an external impact or a problem of a battery cell, the flame may spread to adjacent cells through the empty spaces, resulting in greater damage caused by the fire. Accordingly, methods for reducing the propagation of fire have been continuously studied.

### SUMMARY OF THE INVENTION

According to one aspect of the present disclosure, an object to be achieved is to improve the stability of a battery assembly.

According to another aspect of the present disclosure, an object to be achieved is to delay thermal runaway occurring inside the battery assembly.

According to still another aspect of the present disclosure, an object to be achieved is to enhance the lifespan of the battery assembly.

Meanwhile, the battery assembly according to the present disclosure may be widely applied to green technology fields such as an electric vehicle, a battery charging station, an energy storage system (ESS), and power generation systems using battery cells, including photovoltaics and wind power. In addition, the battery assembly according to the present disclosure may be used in eco-friendly mobility, including electric vehicles and hybrid vehicles, which prevent climate change by suppressing air pollution and greenhouse gas emissions.

A battery assembly according to an embodiment of the present disclosure may include: a plurality of battery cells each including an electrode lead tab portion; a receiving case forming a receiving space that accommodates the plurality of battery cells arranged along a predetermined first direction therein; a barrier member having a plate shape and disposed between the plurality of battery cells along the first direction in the receiving space; a base frame arranged along the first direction in the receiving space; a protrusion portion formed along a second direction, which is one of directions perpendicular to the first direction and extends from the base frame toward the barrier member, wherein at least a portion of the barrier member is inserted into the protrusion portion; and a filling member that contacts and is located between the barrier member and the protrusion portion along a third direction perpendicular to both the first direction and the second direction.

In one embodiment, the filling member may include a contact frame arranged along the third direction.

In one embodiment, the filling member may further include a first frame connected to the contact frame and arranged along the first direction, and a second frame connected to the first frame and arranged along the second direction.

In one embodiment, the battery assembly may further include a fastening member connected to the barrier member and the filling member, wherein the fastening member may include a first groove formed at an upper portion thereof so that the second frame is inserted therein, and a second groove formed at a lower portion thereof so that the barrier member is inserted therein.

In one embodiment, the first frame may be arranged along the first direction and contact the plurality of battery cells, and the contact frame may be arranged along the third direction and contact the barrier member and the protrusion portion.

In one embodiment, the barrier member may be coupled to the second groove by an interference fit.

In one embodiment, a length of the second frame in the second direction may be longer than a length of the barrier member in the second direction.

In one embodiment, the battery assembly may further include a plurality of busbars electrically connecting the electrode lead tab portions of the plurality of battery cells, respectively.

In one embodiment, the filling member may include a polymer, metal, or ceramic material, and may be formed of a solid including a plurality of frames or a foam.

A battery assembly according to an embodiment of the present disclosure may include: a plurality of battery cells each including an electrode lead tab portion, wherein the plurality of battery cells include a plurality of clusters, each cluster being defined as one group including two or more adjacent battery cells among the plurality of battery cells; a receiving case forming a receiving space that accommodates the plurality of battery cells arranged along a predetermined first direction therein; a plurality of barrier members having a plate shape and disposed between the plurality of clusters along the first direction in the receiving space; a base frame arranged along the first direction in the receiving space; a plurality of protrusion portions formed along a second direction, which is one of directions perpendicular to the first direction and extends from the base frame toward the plurality of barrier members, wherein at least a portion of each of the plurality of barrier members is inserted into a corresponding one of the plurality of protrusion portions; and a filling member located between the plurality of barrier members and the plurality of protrusion portions along a third direction perpendicular to both the first direction and the second direction.

In one embodiment, the plurality of protrusion portions may be disposed between adjacent clusters among the plurality of clusters.

In one embodiment, the filling member may include a plurality of contact frames arranged along the third direction.

In one embodiment, the filling member may include a plurality of first frames connected to the plurality of contact frames and arranged along the first direction, and a plurality of second frames connected to the plurality of first frames and arranged along the second direction.

In one embodiment, the battery assembly may further include a plurality of fastening members connected to the plurality of barrier members and the filling member, wherein each of the plurality of fastening members may include a first groove formed at an upper portion thereof so that a corresponding one of the plurality of second frames is inserted therein, and a second groove formed at a lower portion thereof so that a corresponding one of the plurality of barrier members is inserted therein.

In one embodiment, the plurality of first frames may be arranged along the first direction and contact the plurality of battery cells, and the plurality of contact frames may be arranged along the third direction and contact the plurality of barrier members and the plurality of protrusion portions.

In one embodiment, the battery assembly may further include a plurality of busbars electrically connecting the electrode lead tab portions of the plurality of battery cells, respectively.

According to one embodiment of the present disclosure, the stability of the battery assembly can be improved.

According to another embodiment of the present disclosure, thermal runaway occurring inside the battery assembly can be delayed.

According to still another embodiment of the present disclosure, the lifespan of the battery assembly can be enhanced.

### BRIEF DESCRIPTION OF THE DRAWINGS

FIG. 1 is an exploded view of a battery assembly according to the present disclosure.

FIG. 2 illustrates a filling member according to the present disclosure.

FIG. 3 schematically illustrates a battery assembly according to the present disclosure.

FIG. 4A illustrates a state in which a barrier member is coupled to a fastening member according to the present disclosure.

FIG. 4B illustrates a state in which a filling member is coupled to a fastening member according to the present disclosure.

FIG. 4C illustrates a state in which a busbar assembly is coupled to a battery cell according to the present disclosure.

FIG. 5A illustrates a view of the battery assembly of FIG. 3 as seen from one direction.

FIG. 5B illustrates a view of the battery assembly of FIG. 3 as seen from one direction.

### DETAILED DESCRIPTION

Hereinafter, preferred embodiments of the present disclosure will be described in detail with reference to the accompanying drawings. The configuration or control method of the device described below is merely for illustrating the embodiments of the present disclosure and is not intended to limit the scope of the present disclosure. Throughout the specification, the same reference numerals refer to the same components.

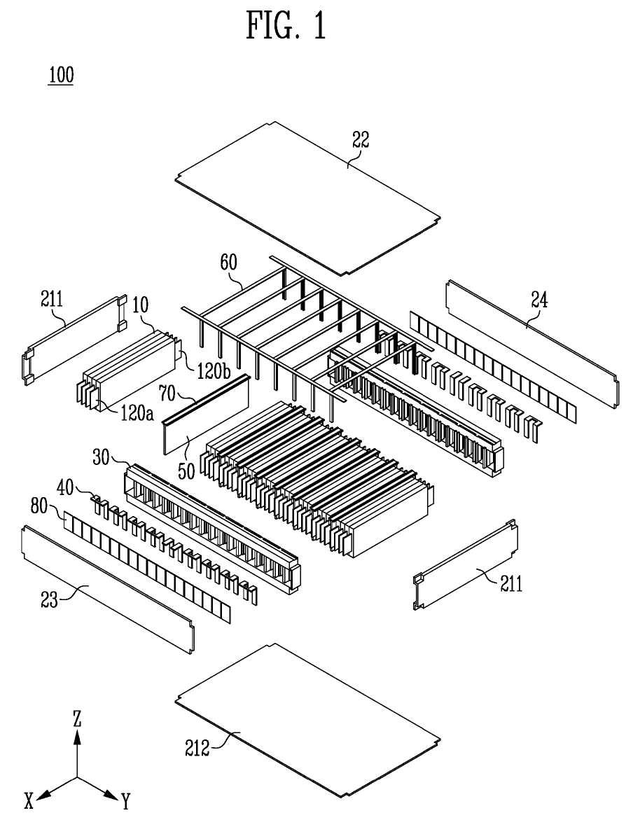

FIG. 1 is an exploded view of a battery assembly according to the present disclosure.

In an embodiment, a battery assembly 100 may comprise a plurality of battery cells 10 each including an electrode lead tab portion 120a, 120b; a receiving case 22, 23, 24, 211, 212 forming a receiving space that accommodates the plurality of battery cells 10 arranged along a predetermined first direction therein; a barrier member 50 having a plate shape and disposed between the plurality of battery cells 10 along the first direction in the receiving space; a base frame 30 arranged along the first direction in the receiving space; a protrusion portion 30a, 30b formed along a second direction, which is one of directions perpendicular to the first direction and extends from the base frame 30 toward the barrier member 50, wherein at least a portion of the barrier member 50 may be inserted into the protrusion portion 30a, 30b; and a filling member 60 located between the barrier member 50 and the protrusion portion 30a, 30b along a third direction perpendicular to both the first direction and the second direction.

For example, referring to FIG. 1, a battery assembly 100 according to the present disclosure may include a plurality of battery cells 10, a receiving case 22, 23, 24, 211, 212 that accommodates the plurality of battery cells 10 therein, a barrier member 50 disposed between the plurality of battery cells 10, a busbar assembly 30, 40, and a filling member 60 that contacts the barrier member 50.

The first direction (Y direction), the second direction (X direction), and the third direction (Z direction) may represent directions orthogonal to each other. The first direction (Y direction) may represent the direction in which the plurality of battery cells 10 are arranged (or stacked). The second direction (X direction) may represent the direction extending from the busbar assembly 30, 40 toward the barrier member 50. The third direction (Z direction) may represent a direction perpendicular to both the first direction (Y direction) and the second direction (X direction).

The plurality of battery cells 10 may each include a cell case containing an electrode assembly and electrode lead tab portions 120a, 120b that are connected to the electrode assembly and protrude outward from the cell case. The cell case may be formed as a pouch-type or cylindrical-type cell case. For example, the pouch-type cell case may be formed of an aluminum laminated film.

In an embodiment, the battery assembly 100 may further comprise a plurality of busbars 40 electrically connecting the electrode lead tab portions 120a, 120b of the plurality of battery cells 10, respectively.

For example, the electrode lead tab portions 120a, 120b may electrically connect each of the plurality of battery cells 10 to the outside. Among the electrode lead tab portions 120a, 120b, one may represent a positive electrode lead tab portion, and the other may represent a negative electrode lead tab portion. The positive electrode lead tab portion and the negative electrode lead tab portion of each of the plurality of battery cells 10 may be formed on one side and/or on the opposite side facing the one side.

The busbar assembly 30, 40 may include a base frame 30 and a busbar 40.

The busbar 40 may electrically connect one of the electrode lead tab portions 120a on one side with at least one other adjacent electrode lead tab portion along the first direction (Y direction). The busbar 40 may also electrically connect one of the electrode lead tab portions 120b on the other side with at least one other adjacent electrode lead tab portion along the first direction (Y direction).

The plurality of battery cells 10 may be arranged along the predetermined first direction (Y direction).

The receiving case 22, 23, 24, 211, 212 may form a receiving space that accommodates the plurality of battery cells 10 therein. The receiving case 22, 23, 24, 211, 212 may include an upper body 22, a lower body 212, and side bodies 23, 24.

The upper body 22 may cover the plurality of battery cells 10.

The lower body 212 may support the plurality of battery cells 10. The lower body 212 may include an opening opened toward the third direction (Z direction) and the second direction (X direction). The plurality of battery cells 10 may be disposed on the lower body 212. The lower body 212 may be formed of a material having high thermal conductivity.

The side bodies 23, 24 may be formed to extend from both edges of the lower body 212. The side bodies 23, 24 may extend from the lower body 212 toward the third direction (Z direction). The side bodies 23, 24 may be formed separately from or integrally with the lower body 212.

The receiving case 22, 23, 24, 211, 212 of the present disclosure may further include an end plate 211. The end plate 211 may be connected to the side bodies 23, 24 and the upper body 22 to cover an open surface of the receiving case 22, 23, 24, 211, 212 in which the plurality of battery cells 10 are accommodated.

The barrier member 50 may be disposed between the plurality of battery cells 10 along the first direction (Y direction). The barrier member 50 may be formed in a plate shape.

In an embodiment, the battery assembly 100 may further comprise a fastening member 70 connected to the barrier member 50 and the filling member 60, wherein the fastening member 70 may include a first groove formed at an upper portion thereof so that the second frame 60b is inserted therein and a second groove formed at a lower portion thereof so that the barrier member 50 is inserted therein.

Further, in an embodiment, the battery assembly 100 may further comprise a plurality of fastening members 70 connected to the plurality of barrier members 50 and the filling member 60, wherein each of the plurality of fastening members 70 may include: a first groove formed at an upper portion thereof so that a corresponding one of the plurality of second frames 60b is inserted therein; and a second groove formed at a lower portion thereof so that a corresponding one of the plurality of barrier members 50 is inserted therein.

For example, the barrier member 50 may be coupled to a fastening member 70. The fastening member 70 may be formed separately from the barrier member 50, or may be formed integrally with the barrier member 50.

The barrier member 50 may block heat propagation between the plurality of battery cells 10.

The busbar assembly 30, 40 may be disposed between the end plate 211 and the plurality of battery cells 10.

The busbar 40 may be connected to the base frame 30. The base frame 30 may be disposed between the busbar 40 and the plurality of battery cells 10.

The base frame 30 may be arranged along the first direction (Y direction). The base frame 30 may include slits (or holes) through which the electrode lead tab portions 120a and 120b of the plurality of battery cells 10 pass. The electrode lead tab portions 120a and 120b of the plurality of battery cells 10 may pass through the slits and be electrically connected to the busbar 40.

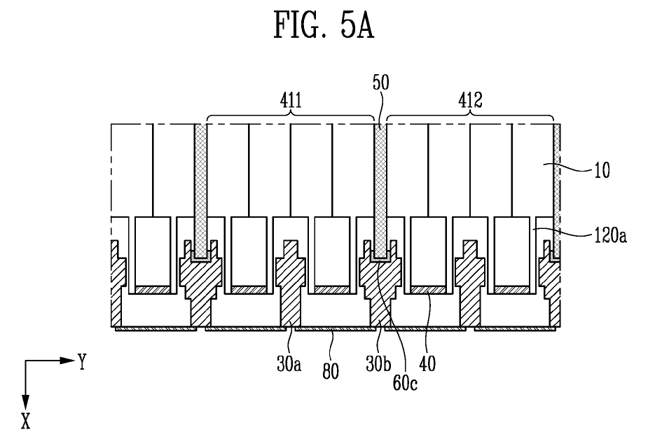

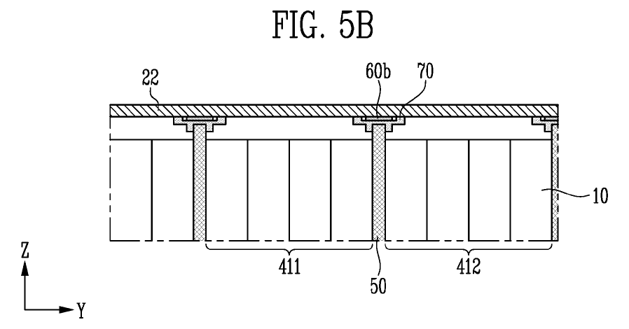

The busbar assembly 30, 40 according to the present disclosure may further include a first protrusion portion 30b (see FIG. 5A) extending from the base frame 30 along the second direction (X direction). The first protrusion portion 30b may be formed integrally with the base frame 30 or may be coupled to and extend from the base frame 30. At least a portion of the barrier member 50 may be inserted into the first protrusion portion 30b.

In an embodiment, the filling member 60 may include a contact frame 60c arranged along the third direction.

For example, the filling member 60 may include frames formed along each of the first direction (Y direction), the second direction (X direction), and the third direction (Z direction). A contact frame 60c of the filling member 60 formed along the third direction (Z direction) may be disposed between the barrier member 50 and the first protrusion portion 30b. A second frame 60b of the filling member 60 formed along the second direction (X direction) may be disposed between the upper body 22 and the barrier member 50. A first frame 60a of the filling member 60 formed along the first direction (Y direction) may be disposed on the base frame 30 and contact the plurality of battery cells 10.

The filling member 60 may be coupled to the fastening member 70.

By being disposed between the barrier member 50 and the first protrusion portion 30b, the filling member 60 may prevent a gap from being formed between the barrier member 50 and the first protrusion portion 30b. Through this, thermal runaway of the plurality of battery cells 10 may be delayed.

The battery assembly 100 according to the present disclosure may further include a heat dissipation member 80. For example, the heat dissipation member 80 may represent a member capable of dissipating heat generated inside the battery assembly 100. For instance, the heat dissipation member 80 may be attached to the busbar assembly 30, 40.

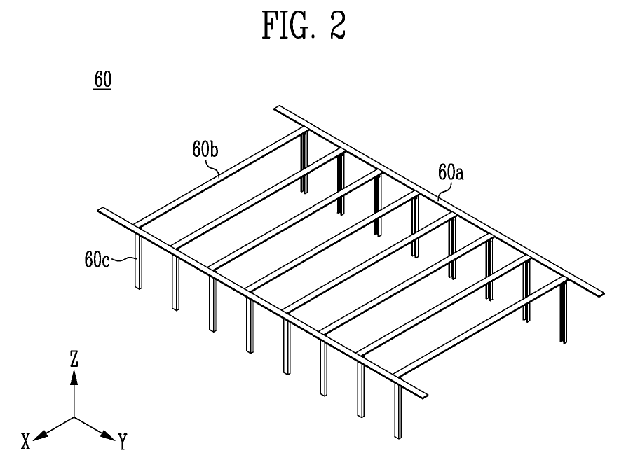

FIG. 2 illustrates a filling member according to the present disclosure.

In an embodiment, the filling member 60 may further comprise a first frame 60a connected to the contact frame 60c and arranged along the first direction and a second frame 60b connected to the first frame 60a and arranged along the second direction.

For example, referring to FIG. 2, a filling member 60 according to the present disclosure may include a first frame 60a arranged along the first direction (Y direction), a second frame 60b arranged along the second direction (X direction), and a contact frame 60c arranged along the third direction (Z direction).

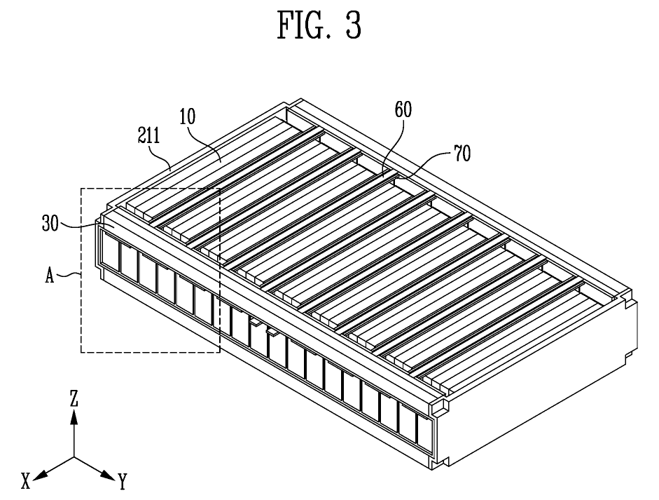

The number of the first frame 60a, the second frame 60b, and the contact frame 60c is not limited to the number illustrated in FIG. 3. In addition, each of the first frame 60a, the second frame 60b, and the contact frame 60c may be formed as a single body or as a plurality of bodies.

For example, the first frame 60a may be formed as two members respectively disposed on both sides of the plurality of battery cells 10 so as to contact electrode lead tab portions 120a and 120b formed on both sides of the plurality of battery cells 10. The second frame 60b and the contact frame 60c may each be formed in a number corresponding to the number of the barrier members 50.

The first frame 60a may be connected to the second frame 60b and the contact frame 60c. The first frame 60a may be a frame that supports the second frame 60b and the contact frame 60c.

One end of the second frame 60b may be connected to the first frame 60a, and the other end of the second frame 60b may be connected to the contact frame 60c.

The contact frame 60c may be in contact with the barrier member 50 and the busbar assembly 30, 40 between the barrier member 50 and the busbar assembly 30, 40.

The first frame 60a may be in contact with the plurality of battery cells 10.

The second frame 60b may be connected to the fastening member 70.

The filling member 60 may include a polymer, metal, or ceramic material. However, this is merely one example, and the material of the filling member 60 of the present disclosure is not limited thereto. The filling member 60 may be formed of a solid or a foam that is cured after injection.

The first frame 60a, the second frame 60b, and the contact frame 60c may be integrally formed.

Alternatively, the first frame 60a may include insertion grooves into which the second frame 60b and the contact frame 60c are inserted. The first frame 60a may also be formed in a structure coupled to the second frame 60b and the contact frame 60c.

FIG. 3 schematically illustrates a battery assembly according to the present disclosure.

More specifically, FIG. 3 illustrates the battery assembly 100 of FIG. 1 with the upper body 22, the lower body 212, and the side bodies 23 and 24 omitted.

Hereinafter, a detailed description will be given of an enlarged view of portion A in FIG. 3.

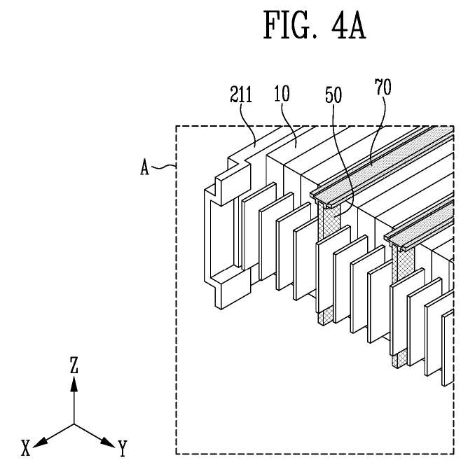

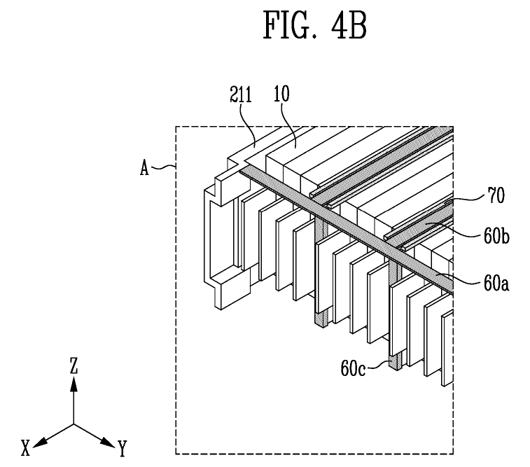

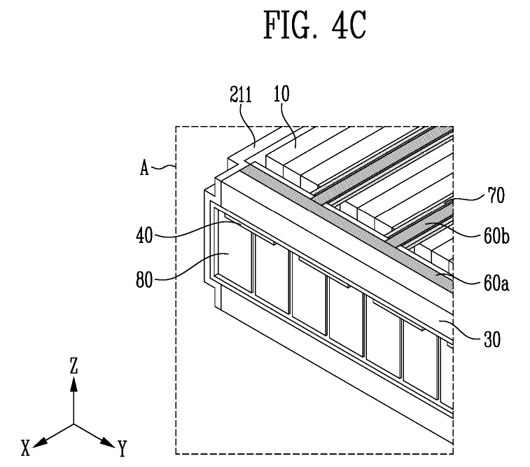

FIG. 4A illustrates a state in which a barrier member is coupled to a fastening member according to the present disclosure.

More specifically, FIG. 4A illustrates a state in which the barrier member 50 and the fastening member 70, which are included in portion A of FIG. 3, are coupled to each other.

The barrier member 50 may be disposed between the plurality of battery cells 10. The barrier member 50 may be formed in a plate shape.

The barrier member 50 may block heat propagation between the plurality of battery cells 10. The barrier member 50 may be formed of a material having heat resistance and thermal insulation properties. For example, the barrier member 50 may include at least one of a mica sheet, silicate, graphite, alumina, ceramic wool (or super wool), and aerogel. However, the material of the barrier member 50 of the present disclosure is not limited thereto and may be made of various materials as long as it can maintain its shape and delay thermal runaway during a thermal runaway situation of the plurality of battery cells 10.

The battery assembly 100 according to the present disclosure may further include a fastening member 70. The fastening member 70 may be disposed between the plurality of battery cells 10 to prevent movement of the barrier member 50 disposed therebetween.

The fastening member 70 may have a first groove formed at an upper portion thereof and a second groove formed at a lower portion thereof. The barrier member 50 may be inserted into the second groove formed at the lower portion of the fastening member 70. A length of the second groove in the first direction (Y direction) may be equal to or slightly shorter than a length of the barrier member 50 in the first direction (Y direction) by a critical value. The second groove and the barrier member 50 may be coupled by an interference fit. The critical value may represent a length of the second groove in the first direction (Y direction) required for an interference fit coupling. However, this is merely one example, and the coupling manner between the second groove and the barrier member 50 is not limited thereto.

A length of the fastening member 70 in the second direction (X direction) may be equal to a length of the barrier member 50 in the second direction (X direction).

The fastening member 70 may be formed separately from the barrier member 50, or may be formed integrally with the barrier member 50.

The barrier member 50 and the fastening member 70 may be formed as a single piece or as a plurality of pieces. The fastening member 70 may be formed in a number corresponding to the number of the barrier members 50.

FIG. 4B illustrates a state in which a filling member is coupled to a fastening member according to the present disclosure.

More specifically, FIG. 4B illustrates a state in which the filling member 60 is coupled to the fastening member 70 of FIG. 4A.

The second frame 60b may be inserted into a first groove formed at an upper portion of the fastening member 70. A length of the second frame 60b in the second direction (X direction) may be greater than a length of the barrier member 50 in the second direction (X direction). The second frame 60b may protrude outward beyond the barrier member 50 along the second direction (X direction).

The first frame 60a may be arranged along the first direction (Y direction) and may contact the plurality of battery cells 10.

The contact frame 60c may be arranged along the third direction (Z direction) and may be disposed between the barrier member 50 and the busbar assembly 30, 40. The contact frame 60c may contact the barrier member 50 and the busbar assembly 30, 40. More specifically, the contact frame 60c may be disposed between the barrier member 50 and the first protrusion portion 30b, and may contact the barrier member 50 and the first protrusion portion 30b.

In an embodiment, the plurality of first frames 60a may be arranged along the first direction and contact the plurality of battery cells 10, and the plurality of contact frames 60c may be arranged along the third direction and contact the plurality of barrier members 50 and the plurality of protrusion portions 30a, 30b.

For example, the contact frame 60c may be disposed between the barrier member 50 and the first protrusion portion 30b so that no gap is formed between the barrier member 50 and the first protrusion portion 30b. Through this configuration, the battery assembly 100 of the present disclosure can delay or reduce thermal runaway of the plurality of battery cells 10.

FIG. 4C illustrates a state in which a busbar assembly is coupled to a battery cell according to the present disclosure.

More specifically, FIG. 4C illustrates a state in which the busbar assembly 30, 40 is coupled to the structure shown in FIG. 4B.

The base frame 30 may be arranged along the first direction (Y direction) in the receiving space of the receiving case 22, 23, 24, 211, 212.

The first frame 60a may be disposed on the base frame 30 and may contact the base frame 30.

The second frame 60b may be arranged along the second direction (X direction), and at least a portion of the second frame 60b may contact the base frame 30.

The base frame 30 may include slits (or holes) through which the electrode lead tab portions 120a and 120b of the plurality of battery cells 10 pass. The electrode lead tab portions 120a and 120b of the plurality of battery cells 10 may pass through the slits and be electrically connected to the busbar 40.

FIG. 5A illustrates a view of the battery assembly of FIG. 3 as seen from one direction.

More specifically, FIG. 5A illustrates a view obtained by cutting portion A of FIG. 3 along a plane defined by the second direction (X direction) and the first direction (Y direction), as viewed from the third direction (Z direction).

In an embodiment, a battery assembly 100 may comprise a plurality of battery cells 10 each including a electrode lead tab portion 120a, 120b, wherein the plurality of battery cells 10 may include a plurality of clusters 411, 412 each defined as one group including two or more adjacent battery cells among the plurality of battery cells 10; a receiving case 22, 23, 24, 211, 212 forming a receiving space that accommodates the plurality of battery cells 10 arranged along a predetermined first direction therein; a plurality of barrier members 20 having a plate shape and disposed between the plurality of clusters 411, 412 along the first direction in the receiving space; a base frame 30 arranged along the first direction in the receiving space; a plurality of protrusion portions 30a, 30b formed along a second direction, which is one of directions perpendicular to the first direction and extends from the base frame 30 toward the plurality of barrier members 20, wherein at least a portion of each of the plurality of barrier members 20 may be inserted into a corresponding one of the plurality of protrusion portions 30a, 30b; and a filling member 60 located between the plurality of barrier members 20 and the plurality of protrusion portions 30a, 30b along a third direction perpendicular to both the first direction and the second direction.

For example, the plurality of battery cells 10 may include a plurality of clusters, each defined as one group including two or more adjacent battery cells among the plurality of battery cells 10. For example, the plurality of clusters may include a first cluster 411 and a second cluster 412, each composed of four battery cells. However, this is merely one example, and the number of battery cells constituting one cluster is not limited thereto.

The barrier member 50 may be disposed between the plurality of clusters. For example, the barrier member 50 may be disposed between the first cluster 411 and the second cluster 412.

The busbar assembly 30, 40 may include a base frame 30, a first protrusion portion 30b, a second protrusion portion 30a, and a busbar 40. The busbar 40 may be coupled to the base frame 30. The first protrusion portion 30b and the second protrusion portion 30a may be formed to extend from the base frame 30 and may be formed integrally with the base frame 30. The base frame 30 may be disposed between the plurality of battery cells 10 and the busbar 40.

The busbar 40 may electrically connect one electrode lead tab portion 120a on one side with at least one other adjacent electrode lead tab portion along the first direction (Y direction). The busbar 40 may also electrically connect one electrode lead tab portion 120b on the other side with at least one other adjacent electrode lead tab portion along the first direction (Y direction).

The base frame 30, to which the heat dissipation member 80 is attached, may be arranged along the first direction (Y direction). The base frame 30 may be formed in a plate shape. For example, the heat dissipation member 80 may represent a member capable of dissipating heat generated inside the battery assembly 100. For instance, the heat dissipation member 80 may be attached to the base frame 30.

The base frame 30 may include slits (or holes) through which the electrode lead tab portions 120a and 120b of the plurality of battery cells 10 pass. The electrode lead tab portions 120a and 120b of the plurality of battery cells 10 may pass through the slits and be connected to the busbar 40.

The first protrusion portion 30b and the second protrusion portion 30a may be formed to extend from the base frame 30 along the second direction (X direction), which is perpendicular to the first direction (Y direction), toward the barrier member 50.

The first protrusion portion 30b may be disposed between adjacent clusters among the plurality of clusters. For example, the first protrusion portion 30b may be disposed between the first cluster 411 and the second cluster 412.

The first protrusion portion 30b may be formed in a concave shape toward the barrier member 50, while the second protrusion portion 30a may be formed in a convex shape toward the barrier member 50. The first protrusion portion 30b and the second protrusion portion 30a may be alternately formed from the base frame 30 along the second direction (X direction).

The first protrusion portion 30b and the second protrusion portion 30a may be disposed between electrode lead tab portions 120a of the plurality of battery cells 10 that are not electrically connected to each other by the busbar 40.

At least a portion of the barrier member 50 may be inserted into the first protrusion portion 30b. The contact frame 60c of the filling member 60 may contact the barrier member 50 and the first protrusion portion 30b between the barrier member 50 and the first protrusion portion 30b along the third direction (Z direction). The filling member 60 may prevent a gap from being formed between the first protrusion portion 30b and the barrier member 50. By being disposed between the first protrusion portion 30b and the barrier member 50, the filling member 60 may contact both the first protrusion portion 30b and the barrier member 50. Through this configuration, the filling member 60 may separate the plurality of clusters and prevent heat from propagating between the plurality of clusters.

The second protrusion portion 30a may not receive insertion of the barrier member 50. The second protrusion portion 30a may prevent adjacent electrode lead tab portions 120a and 120b from being connected to each other, thereby preventing an electrical short circuit.

FIG. 5B illustrates a view of the battery assembly of FIG. 3 as seen from one direction.

More specifically, FIG. 5B illustrates a view obtained by cutting portion A of FIG. 3 along a plane defined by the first direction (Y direction) and the third direction (Z direction), as viewed from the second direction (X direction).

The barrier member 50 may be inserted into a second groove formed at a lower portion of the fastening member 70. A second frame 60b of the filling member 60, which is arranged along the second direction (X direction), may be inserted into a first groove formed at an upper portion of the fastening member 70. The upper body 22 may contact the fastening member 70 arranged along the second direction (X direction). The upper body 22 may also contact the second frame 60b arranged along the second direction (X direction). Through this configuration, the filling member 60 may prevent a gap from being formed between the fastening member 70 and the barrier member 50, thereby delaying thermal runaway of the plurality of battery cells 10.

The present disclosure may be embodied in various forms, and the scope of the present disclosure is not limited to the above-described embodiments. Therefore, if a modified embodiment includes the constituent elements of the claims of the present disclosure, it should be construed as being within the scope of the present disclosure.

What is claimed is:

1. A battery assembly comprising:
a plurality of battery cells each including an electrode lead tab portion;
a receiving case forming a receiving space that accommodates the plurality of battery cells arranged along a predetermined first direction therein;
a barrier member having a plate shape and disposed between the plurality of battery cells along the first direction in the receiving space;
a base frame arranged along the first direction in the receiving space;
a protrusion portion formed along a second direction, which is one of directions perpendicular to the first direction and extends from the base frame toward the barrier member, wherein at least a portion of the barrier member is inserted into the protrusion portion; and
a filling member located between the barrier member and the protrusion portion along a third direction perpendicular to both the first direction and the second direction.

2. The battery assembly according to claim 1, wherein the filling member includes a contact frame arranged along the third direction.

3. The battery assembly according to claim 2, wherein the filling member further comprises:
a first frame connected to the contact frame and arranged along the first direction; and
a second frame connected to the first frame and arranged along the second direction.

4. The battery assembly according to claim 3, further comprising a fastening member connected to the barrier member and the filling member,
wherein the fastening member includes:
a first groove formed at an upper portion thereof so that the second frame is inserted therein; and
a second groove formed at a lower portion thereof so that the barrier member is inserted therein.

5. The battery assembly according to claim 3, wherein the first frame is arranged along the first direction and contacts the plurality of battery cells, and the contact frame is arranged along the third direction and contacts the barrier member and the protrusion portion.

6. The battery assembly according to claim 4, wherein the barrier member is coupled to the second groove by an interference fit.

7. The battery assembly according to claim 3, wherein a length of the second frame in the second direction is longer than a length of the barrier member in the second direction.

8. The battery assembly according to claim 1, further comprising a plurality of busbars electrically connecting the electrode lead tab portions of the plurality of battery cells, respectively.

9. The battery assembly according to claim 1, wherein the filling member is formed of a solid including a plurality of frames or a foam that is cured after injection, and includes a polymer, metal, or ceramic material.

10. A battery assembly comprising:
a plurality of battery cells each including an electrode lead tab portion,
wherein the plurality of battery cells include a plurality of clusters each defined as one group including two or more adjacent battery cells among the plurality of battery cells;
a receiving case forming a receiving space that accommodates the plurality of battery cells arranged along a predetermined first direction therein;
a plurality of barrier members having a plate shape and disposed between the plurality of clusters along the first direction in the receiving space;
a base frame arranged along the first direction in the receiving space;
a plurality of protrusion portions formed along a second direction, which is one of directions perpendicular to the first direction and extends from the base frame toward the plurality of barrier members,
wherein at least a portion of each of the plurality of barrier members is inserted into a corresponding one of the plurality of protrusion portions; and
a filling member located between the plurality of barrier members and the plurality of protrusion portions along a third direction perpendicular to both the first direction and the second direction.

11. The battery assembly according to claim 10, wherein the plurality of protrusion portions are disposed between adjacent clusters among the plurality of clusters.

12. The battery assembly according to claim 10, wherein the filling member includes:
a plurality of contact frames arranged along the third direction;
a plurality of first frames connected to the plurality of contact frames and arranged along the first direction; and
a plurality of second frames connected to the plurality of first frames and arranged along the second direction.

13. The battery assembly according to claim 12, further comprising a plurality of fastening members connected to the plurality of barrier members and the filling member,
wherein each of the plurality of fastening members includes:
a first groove formed at an upper portion thereof so that a corresponding one of the plurality of second frames is inserted therein; and
a second groove formed at a lower portion thereof so that a corresponding one of the plurality of barrier members is inserted therein.

14. The battery assembly according to claim 12, wherein the plurality of first frames are arranged along the first direction and contact the plurality of battery cells, and the plurality of contact frames are arranged along the third direction and contact the plurality of barrier members and the plurality of protrusion portions.

15. The battery assembly according to claim 10, further comprising a plurality of busbars electrically connecting the electrode lead tab portions of the plurality of battery cells, respectively.
